(19) United States
(12) Patent Application Publication
(10) Pub. No.: US 2017/0139616 A1
(43) Pub. Date: May 18, 2017

(54) METHOD OF DECREASING WRITE AMPLIFICATION FACTOR AND OVER-PROVISIONING OF NAND FLASH BY MEANS OF DIFF-ON-WRITE APPROACH

(71) Applicant: HGST Netherlands B.V., Amsterdam (NL)

(72) Inventors: Viacheslav Anatolyevic DUBEYKO, San Jose, CA (US); Cyril GUYOT, San Jose, CA (US)

(21) Appl. No.: 14/944,043

(22) Filed: Nov. 17, 2015

(51) Int. Cl. G06F 3/06; G06F 12/02; G06F 12/08

(52) U.S. Cl. CPC G06F 3/0619; G06F 12/0802; G06F 12/0246; G06F 3/0644; G06F 3/064; G06F 3/0685; G06F 2212/1032; G06F 2212/2022; G06F 2212/222; G06F 2212/60; G06F 2212/7205

(57) ABSTRACT

Methods and systems for reducing write amplification and over-provisioning of flash memory devices are disclosed herein. The approaches described herein are especially useful for decreasing write amplification and over-provisioning in the case of small files or files with gradually growing content. In the case of smaller files, small portions or small updates to files are stored in a NAND flash page of a Journal area. This approach both decreases write amplification and over-provisioning, and also improves garbage collection efficiency. For gradually growing file content, different updates to the file can be stored in Journal areas of different logs. Every diff/update will share space in a NAND flash page with updates of other files. Subsequently, all available updates in the Journal Area for the same logical block of the growing file will be joined and saved if the total amount of updates will be equal to NAND flash page size.

### CROSS REFERENCE TO RELATED APPLICATION

This application claims the benefit of the co-pending, commonly-owned US patent application with Attorney Docket No. HGST-H20151074US1, Ser. No. ______, filed on ______, by Dubeyko, et al., and titled “METHOD OF IMPROVING GARBAGE COLLECTION EFFICIENCY OF FLASH-ORIENTED FILE SYSTEMS USING A JOURNALING APPROACH”, and hereby incorporated by reference in its entirety.

This application claims the benefit of the co-pending, commonly-owned US patent application with Attorney Docket No. HGST-H20151075US1, Ser. No. ______, filed on ______, by Dubeyko, et al., and titled “METHOD OF DECREASING WRITE AMPLIFICATION OF NAND FLASH USING A JOURNAL APPROACH”, and hereby incorporated by reference in its entirety.

### FIELD

Embodiments of the present invention generally relate to data storage systems. More specifically, embodiments of the present invention relate to systems and methods for reducing write amplification and over-provisioning in flash-oriented file systems by means of a Diff-on-Write approach.

### BACKGROUND

Write amplification is an undesirable phenomenon associated with flash memory and solid-state drives (SSDs). All SSDs have a write amplification factor that is based on what is currently being written to the SSD and what has already been written the SSD. In general, write amplification is determined by the ratio of data written to the flash memory device to data written by the host. The more data that is written to the flash memory device compared to data that is written by the host, the greater the write amplification value. In general, data is written into segments of an SSD, which are an aggregation of several NAND flash erase blocks.

Several factors contribute to a write amplification factor associated with an SSD. Many SSDs implement a wear-leveling policy so that NAND flash erase blocks experience uniform wear. Such policies dictate that data is regularly moved from aged segments into new segments, thus increasing the write amplification factor of the SSD. Another factor that contributes to write amplification is the Copy-On-Write policy employed by many SSDs. Copy-On-Write refers to a practice or policy of copying every updated block to a new physical page of NAND flash because a clean physical page of a NAND chip can be written only once.

TRIM commands may be issued by the operating system in an attempt to mitigate write amplification. These commands indicate to the storage device which sectors contain invalid data. The SSD can retrieve these commands and reclaim any pages containing invalid sectors as free space when the blocks containing these pages are erased rather than copying invalid data to clean pages. While this approach may mitigate write amplification to a degree, write amplification remains a major concern for SSD storage systems. Furthermore, prior techniques are unable to resolve write amplification issues for small files, and inefficient garbage collection can increase write amplification significantly. Therefore, there is a need to for improved methods to decrease write amplification factor and over-provisioning of NAND flash.

### SUMMARY

Methods and systems for managing data storage in flash memory devices are described herein. Embodiments of the present invention utilize a Diff-On-Write approach to reduce write amplification and over-provisioning of flash memory devices.

According to one embodiment, a method for decreasing write amplification of a flash memory device is disclosed. The method includes storing content of a file in a NAND flash page of the flash memory device, receiving an update request comprising new data associated with the content, determining a difference between the new data and the content, writing the difference to a page cache associated with a journal area of a log stored in main memory, where the log comprises a main area for storing an initial file state of the file and an update area for storing updates to the initial file state, and distributing the log across multiple NAND flash pages of the flash memory device.

According to another embodiment, an apparatus for reducing a write amplification of a flash memory device is disclosed. The apparatus includes a flash memory device comprising a plurality of logs, wherein each of the plurality of logs comprises a main area, a journal area, and an update area, a main memory, and a processor communicatively coupled to the main memory and the flash memory device that stores content of a file in a NAND flash page of the flash memory device, receives an update request comprising new data associated with the content, determines a difference between the new data and the content, writes the difference to a page cache associated with a journal area of a log stored in the main memory, where the log comprises a main area for storing an initial file state of the file and an update area for storing updates to the initial file state, and distributes the log across multiple NAND flash pages of the flash memory device.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a flow chart depicting an exemplary sequence of computer implemented steps for identifying relevant updates to be made to areas of memory during flash memory garbage collection according to embodiments of the present invention.

FIG. 2 is a block diagram depicting an exemplary computer system for managing a data storage system using a Diff-On-Write (DOW) approach, according to embodiments of the present invention.

FIG. 3 is a block diagram illustrating exemplary data chunk accumulation in the Journal area of memory according to embodiments of the present invention.

FIG. 4 is a block diagram illustrating exemplary data accumulation and transfer in the Journal, Update and Main areas of memory according to embodiments of the present invention.

FIG. 5 is a block diagram illustrating exemplary Copy-On-Write (COW) and Diff-On-Write (DOW) approaches for writing data to flash memories according to embodiments of the present invention.

FIG. 6 is a block diagram of an exemplary table identifying a status of a Main area block according to embodiments of the present invention.

FIG. 7 is a block diagram of an exemplary set of logs of a log-structured file system for performing an exemplary DOW method according to embodiments of the present invention.

FIG. 8 is a flow chart depicting an exemplary sequence of computer implemented steps for storing data of a file in a Main area, a Diff Updates area, and a Journal area of a log of flash-oriented file system volume according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

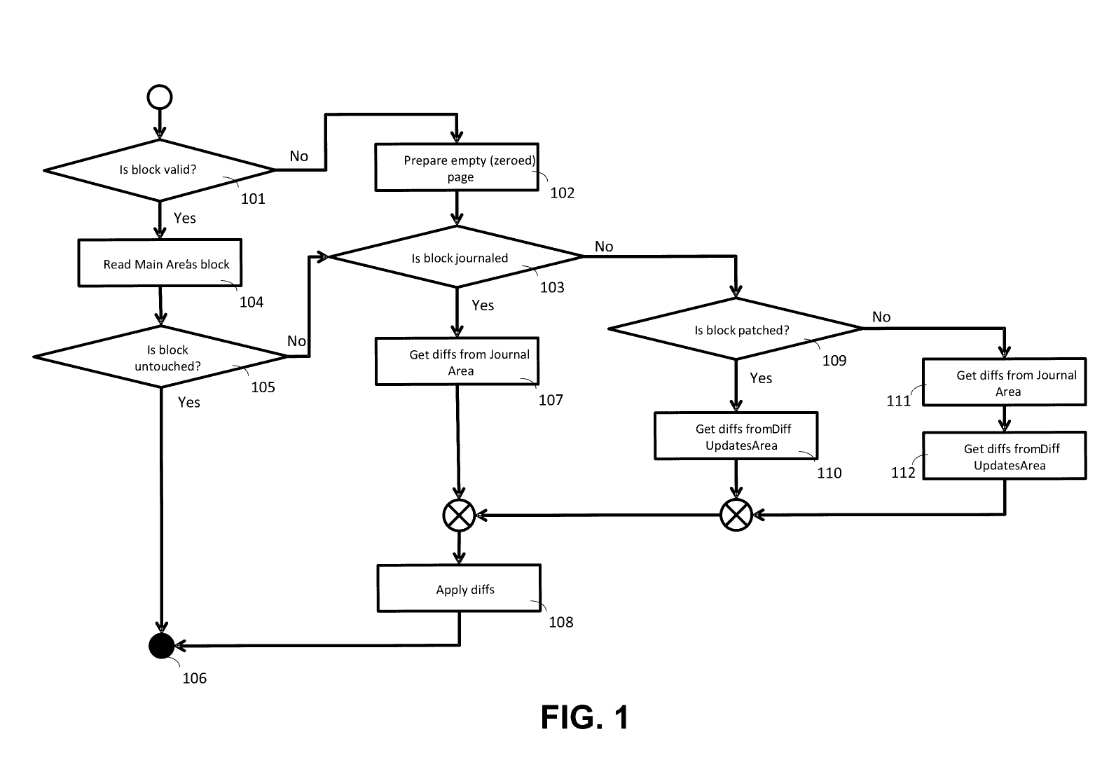

Portions of the detailed description that follows are presented and discussed in terms of a method. Although steps and sequencing thereof are disclosed in a figure herein (e.g., FIG. 1) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Method of Decreasing Write Amplification and Over-Provisioning Using Diff-on-Write Approach

The following description is presented to enable a person skilled in the art to make and use the embodiments of this invention; it is presented in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

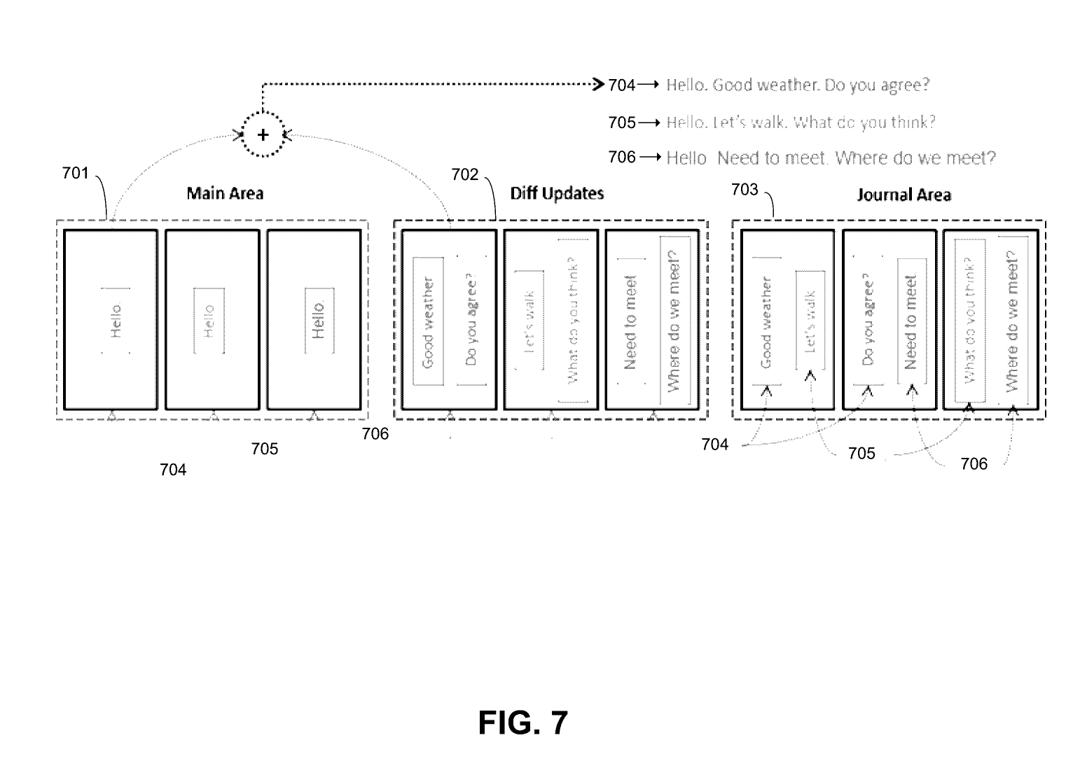

According to embodiments of the present invention, a Diff-On-Write (DOW) approach is utilized to reduce write amplification and over-provisioning in flash-oriented file systems. In a typical Copy-On-Write (COW) approach, every updated block is to be copied to a new location. In contrast, a DOW approach only stores the difference (“diff”) between an initial data state and an updated data state of a file (see FIG. 7). Each new update to a file may be stored as a new diff. In general, a new diff is the result of a creating a new file, adding data to an existing file, or updating a portion of a file.

According to one DOW approach, user data stored on a file system volume is classified as “cold”, “warm”, or “hot” in regard to the frequency of updates associated with a given file. Specifically, cold data is basically unchanged during the lifetime of the data. In other words, cold data can essentially treated as “read-only” data because it is almost never changed or updated. Warm data is updated in small amounts from time to time and more frequently than cold data. Hot data comprises the most frequently updated data on a file system volume.

A log-structured file system typically divides the file system's volume into chunks called segments. The segments have a fixed size and are a basic item for allocating free space on the file system volume. Each segment comprises one or more NAND flash blocks (e.g., erase blocks). User data is saved on the volume as a log, which is a segment-based portions of user data combined with metadata. Each erase block includes one or more logs. Based on the classification of data as “cold”, “warm”, and “hot”, user data is distributed to three different conceptual areas of a log using a DOW approach. According to some embodiments, a segment's log is conceptually divided into a “Main” area, a “Diff Updates” area, and a “Journal” area. The Main area contains “cold” data that describes an initial state of a file. Updates to a file's content are “hot” data that is updated frequently and stored in the Journal area, first. One NAND flash page of a Journal area can contain diffs from different files. Several diffs for the same file can be combined and stored in one NAND page of the Diff Updates area. Such aggregation of several diffs for the same file will be less frequent than for Journal area.

In one exemplary DOW approach, a file named “File 1” comprises a string “Hello” equal to 6 bytes in size and stored in a Journal area of a segment's log of the file system volume. The Journal area provides a shared space for gathering updates of different files. Therefore, the Journal area is a mixed sequence of updates for different files. When the Journal areas in one or several logs have gathered enough updates for a file such that the accumulated size of the updates this file is equal to a NAND flash page size, these updates may be joined and written to a single NAND flash page of the Diff Updates or Main areas. Updates to the cold data (Main area) are stored in a Journal or a Diff Updates areas of a segment's log of the file system volume. At first one or several a file's small updates (diffs) are stored in Journal area. The updates will be written to the Diff Updates area when the updates are associated with different parts of a file have the accumulated size is equal to a NAND flash page size. The updates will be written to the Main area of the log when the updates are associated with the same part of the file (e.g., the same NAND flash page or the same logical block) have the accumulated size is equal to a NAND flash page size and the write operation has goal to change logical block's state from pre-allocated to allocated or to create a new checkpoint for a logical block.

The DOW approaches described herein are especially useful for decreasing write amplification and over-provisioning in the case of small files (e.g., less than 4-16 KB) or files with gradually growing content. According to some embodiments, in the case of smaller files, small portions or small updates to files are stored in a NAND flash page of a Journal area. In general, 61% of all files on a file system volume are smaller than 10 KB. See John R. Douceur and William J. Bolosky, “A Large-Scale Study of File-System Contents”, SIGMETRICS '99 Proceedings of the 1999 ACM SIGMETRICS international conference on Measurement and modeling of computer systems, Pages 59-70, 1999, Nitin Agrawal, William J. Bolosky, John R. Douceur, Jacob R. Lorch, “A Five-Year Study of File-System Metadata”, ACM Transactions on Storage (TOS), Volume 3 Issue 3, October 2007, and Yinjin Fu; Hong Jiang; Nong Xiao; Lei Tian; Fang Liu, “AA-Dedupe: An Application-Aware Source Deduplication Approach for Cloud Backup Services in the Personal Computing Environment,” Cluster Computing (CLUSTER), 2011 IEEE International Conference on, vol., no., pp. 112, 120, 26-30 Sep. 2011, which are hereby incorporated by reference. The DOW approach both decreases write amplification and over-provisioning, and also improves garbage collection efficiency. In the case of gradually growing file content, different updates to the file can be stored in Journal areas of different logs. Every diff/update will share space in a NAND flash page with updates of other files. Subsequently, all available updates in the Journal Area for the same logical block of the growing file will be joined and saved into a Main area if the total amount of updates will be equal to NAND flash page size.

Furthermore, the DOW approaches described herein are also particularly good for decreasing write amplification for mixed workloads. For example, an exemplary workload may comprise adding new data to the end of a file and updating an area in the middle of a file. As discussed above, diffs/updates can be stored in a Journal area of different logs. Subsequently, diffs of one file can be moved into a Diff Updates area to enable different updates of different areas of the file to be joined into a single NAND flash page. Finally, a sequence of contiguous diffs from Diff Updates and/or Journal areas are joined into one NAND flash page of the Main area.

FIG. 1 illustrates an exemplary process of reconciling data from Main, Update and Journal areas of segment logs of a flash-oriented file system volume according to embodiments of the present invention. The flash memory device may be a solid state drive (SSD) or a NAND-based flash memory, for example. A file system's logical blocks can be in four states: (1) clean; (2) pre-allocated; (3) valid; (4) invalid. The “pre-allocated” and “valid” logical block may have updates. An “invalid” block is associated with obsolete data and has no associated updates.

The first determination is whether or not a logical block of the Main area of a log is valid (101). If it is determined that the logical block is not a valid block, then the block is considered invalid/pre-allocated and no action is required. If the block is invalid then the block cannot have any updates. For performing garbage collection, an empty main memory page(s) may be prepared (102). When a file's logical block contains content equal to the NAND flash page in size, the Main Area will contain an initial state of this part of the file. If a logical block has content smaller than NAND flash page in size or it has only one small update (for example, 120 bytes) then the Journal area will include diff for this logical block number (“journaled” state). Subsequently, the process determines if the logical block is journaled, meaning that modifications exist in the Journal area, but not in the Diff Updates area (103). If the Main area contains the logical block's content and this logical block was updated several times and these updates were gathered in Diff Updates area, then the Diff Updates area will contain the diff(s) update (for example, 4 Kbytes of aggregated size for the case of a “patched” state). If the logical block is determined to be valid at step 101, a block from the main area is read (104). An untouched logical block at step 105 is written (106) and the process ends. Alternatively, if the logical block is not untouched at step 105, the process proceeds to step 103. For journaled logical blocks, diffs are gathered from the journal area (107). At step 108, the diffs are applied and the logical block is written at step 106.

At step 103, if the logical block is not journaled, it is determined if the logical block is patched, meaning that some updates to the Main area logical block exist in the Diff Updates area but not in the Journal area (109). If so, the diffs are retrieved from the Diff Updates area (110). If the logical block is not patched at step 109, the process continues to step 111 where diffs from the Journal area are gathered. Next, at step 112, diffs from the Diff Updates area are gathered. At step 108, the diffs are applied and at step 106 the data is written.

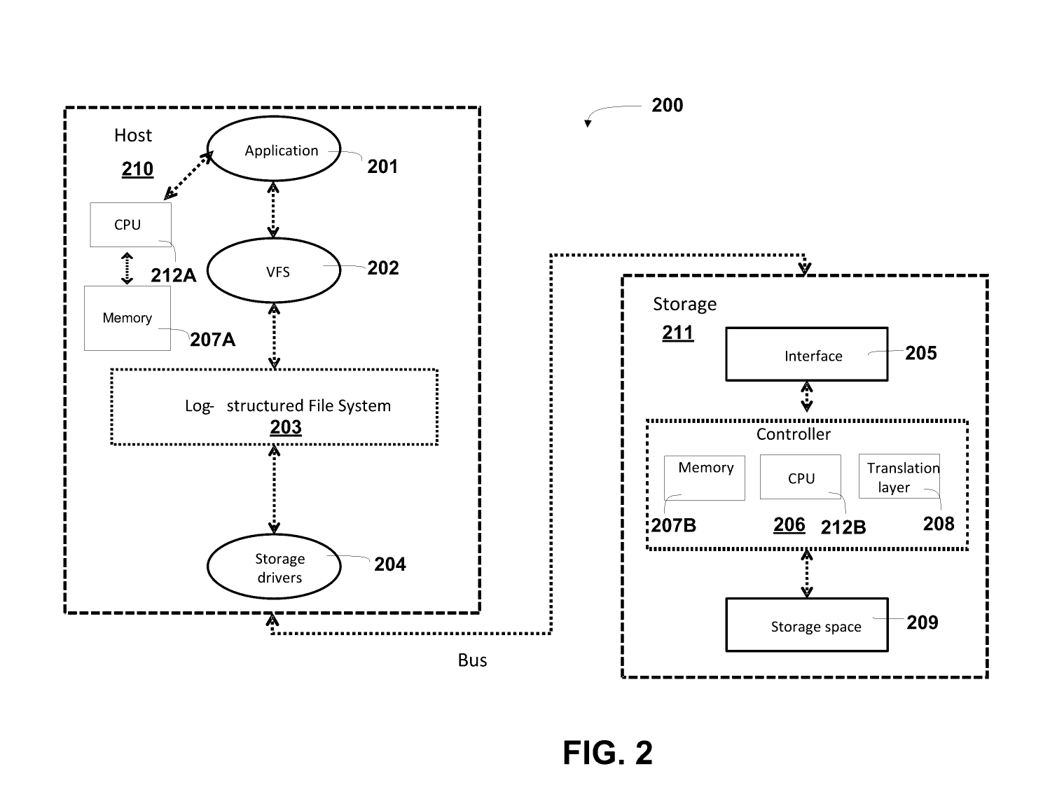

FIG. 2 illustrates an exemplary computer system 200 for managing a data storage system using a DOW approach. Host 210 is communicatively coupled to Storage 211 using a bus, for example. Application 201 running on Host 210 is a user-space application and may comprise any software capable of initiating requests for storing or retrieving data from a persistent storage device. Application 201 communicates with Virtual File System Switch (VFS) 202, a common kernel-space interface that defines what file system will be used for requests from user-space applications (e.g., application 201). Log structured file system 203 is maintained on Host 210 for storing data using storage drivers 204. Storage drivers 204 may comprise a kernel-space driver that converts a file system's (or block layer's) requests into commands and data packets for an interface that is used for low-level interaction with a storage device (e.g., storage 211). Memory 207A comprises DRAM and stores volatile data. The DRAM is used to construct segments' logs to be written to storage space 209.

Storage 211 comprises an interface for enabling low-level interactions (physically and/or logically) with storage device 211. For example, the interface may utilize SATA, SAS, NVMe, etc. Usually, every interface is defined by some specification. The specification strictly defines physical connections, available commands, etc. Storage 211 further comprises a controller 206 optionally having a memory 207B and a translation layer 208. In the case of SSDs, the translation layer may comprise a FTL (Flash Translation Layer). Typically an FTL is on the SSD-side, but it can also be implemented on the host side. The goals of FTL are: (1) map logical numbers of NAND flash blocks into physical ones; (2) garbage collection; and (3) implementing wear-leveling. Data is written to and read from storage space 209 using controller 206. According to some embodiments, System 200 further comprises CPU 212A and/or CPU 212B. CPU 212A of Host 210 performs Diff-On-Write operations for writing data to storage space 209 using controller 206.

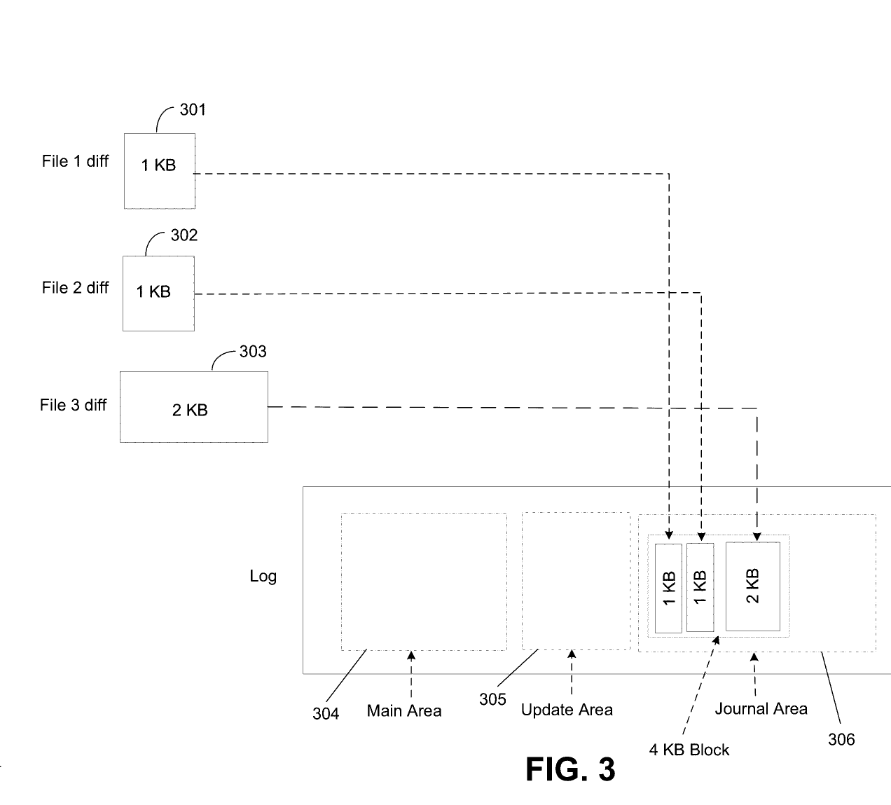

FIG. 3 illustrates an exemplary process of accumulating sub-block-size elements in the Journal area (306), according to embodiments of the present invention. Initially, diffs are placed into Journal Area. When several small updates are stored in the Journal Area for different logical block of the same file and these updates are equal to NAND flash page in size, the diffs are moved into a NAND flash page of the Diff Updates Area.

Segment's log with Main, Diff Updates, and Journal areas are initially constructed using DRAM memory and are subsequently written to NAND flash pages of a file system volume. In the example of FIG. 3, concurrent updates for different files of size 1 KB (301), 1 KB (302) and 2 KB (303) are stored in the Journal area (306). Each file can be updated simultaneously using dedicated threads. Several small updates (diffs) of several different files can be gathered into one logical block of a Journal area. According to some embodiments, only full logical blocks are written to the Main area (304) and only full NAND flash pages are written in any area (e.g., Main, Diff Updates, and Journal). According to some embodiments, the Diff Updates area (305) is dedicated to storing sub-block size elements as well.

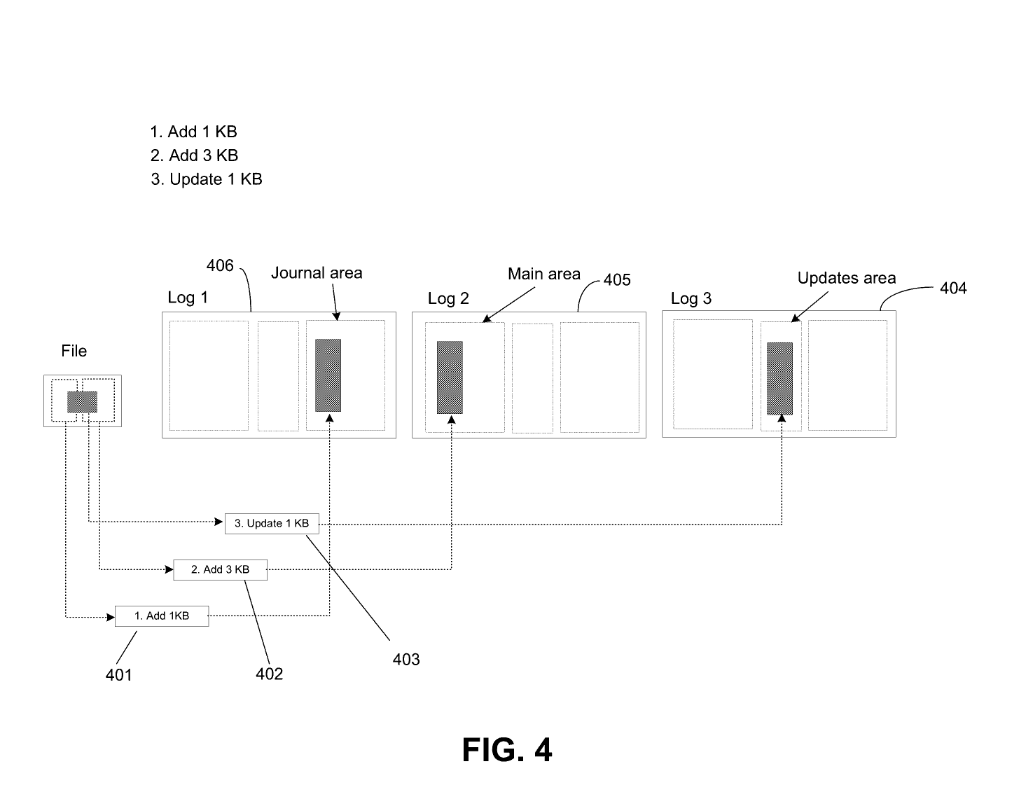

FIG. 4 further illustrates an exemplary accumulation process according to embodiments of the present invention. According to one illustrative example, a file of size 1 KB (401) is first stored in the Journal area (406). An addition of 3 KB (402) to that file makes the size of the file 4 KB so the file is transferred to the Main area (405). A further modification of size 1 KB or more (403) to the file will be inscribed in the Update area (404).

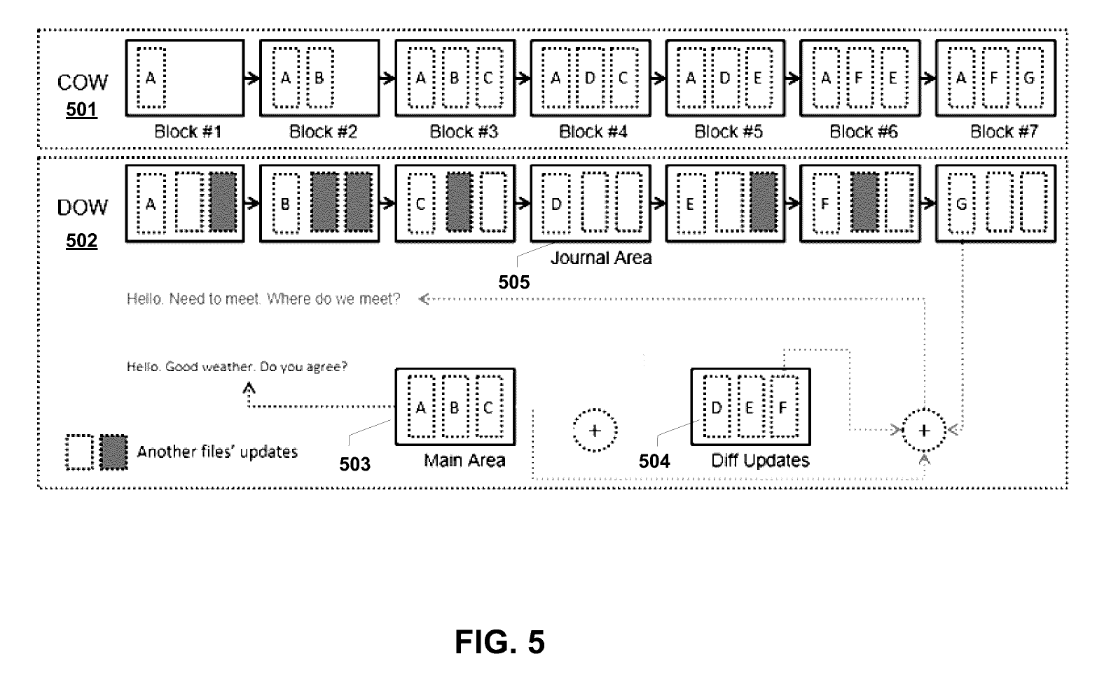

FIG. 5 shows an exemplary application of the Diff-On-Write (DOW) method 502 and the results of COW 501 on a succession of modifications to NAND flash pages, where an entire page is written at once, according to embodiments of the present invention. An exemplary application of COW 501 is also depicted in FIG. 5 for comparison, where a logical block (or NAND flash page) is inscribed with item A. To add a second element B to the file requires that a new logical block (or NAND flash page) be written to contain A+B. Similarly, the addition of C to this file requires a new logical block (or NAND flash page), now with A+B+C. It is important to note that initially changes are stored into a page cache (e.g., DRAM memory). Changes to content inside a file does not necessarily mean that DRAM memory pages and NAND flash pages are immediately reconciled. The file system can be mounted in synchronous mode, and in this case, a file system driver writes changed content into a NAND flash pages as soon as possible. Otherwise, the file system driver has flexibility to choosing a time for a flushing operation. If a small change has been made to file content only, then the small change is stored in a NAND flash page regardless. However, if there are several small and fast changes to file content, the sequence of changes can be aggregated in DRAM memory first, and cumulative changes can later be saved into NAND flash.

To apply a modification of B to D—which can be as small as a singular character alteration—COW 501 requires that changed content be written into another NAND flash page, this time to contain A+D+C. Further modifications to the intended contents of the file will each require a complete re-write to a new NAND flash page. Thus, modifying C to E, D to F, and E to G will cause three more re-writes, so that the ultimate goal of having content A+F+G requires 7 logical block (or NAND flash pages) writes.

Still with regard to FIG. 5, and in contrast to the COW approach 501, an exemplary DOW 502 approach is depicted according to embodiments of the present invention. A Journal area 505 comprising 7 logical blocks is depicted, as well as 1 logical block of Main Area 503, 1 logical block of Diff Updates Area 504 and, exemplary strings that can be extracted from different logical blocks and to represent a file's content at different moments of time. The logical blocks of Journal Area 505 contain a part of the file and parts of other files. When part A of the file is received, it can be aggregated into DRAM memory page with parts of other simultaneously updated files. This may be repeated several times.

When several parts of the same logical block of the file (for example, 4 KB in aggregated size) are aggregated in the Journal Area, they can be gathered from the Journal Area 505 and written into one logical block of the Main Area. As depicted, the logical block of the Main Area contain parts A, B, C of the file. These three parts make up string “Hello. Good weather. Do you agree?” (part A—“Hello.”, part B—“Good weather.”, part C—“Do you agree?”). Then additional updates D, E, F of the file's content will be stored into the Journal Area 505 with simultaneous updates of other files. Once enough file updates have been gathered to fill the whole logical block (e.g., 4 KB in sum) the three updates D, E, F are collected into one logical block and saved into Diff Updates Area. This is because the same file's logical block is updated by means of the D, E, F diffs. It is important to remember that updates of logical block(s) in the Main Area 503 are initially stored in Diffs Update Area. Then, when significant amounts of such updates are accumulated, the logical block of the Main Area 503 with updated content is moved from one log into another one. If we consider all A, B, C, D, and E updates, the file's content is the string “Hello. Let's walk. What do you think.” As depicted, the DOW approach 502 advantageously requires many fewer complete NAND flash page re-writes compared to the COW approach 501.

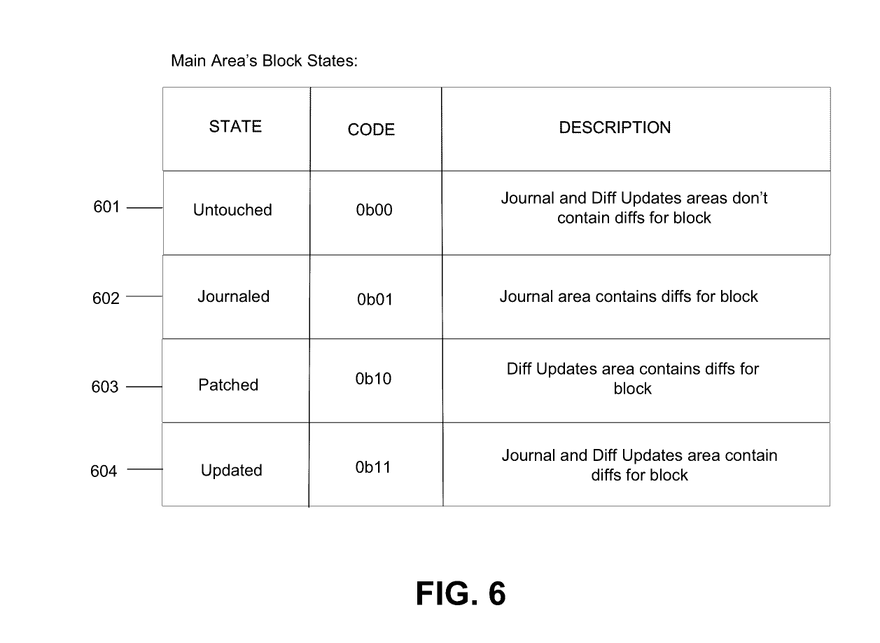

FIG. 6 shows an exemplary table identifying a status of a Main area logical block, according to embodiments of the present invention. According to one exemplary embodiment, a bit code of 00 may be used to indicate that no modifications to the Main area's logical block exist in the Diff Update and Journal areas. A particular logical block of the Main area with this bit code would be considered ‘Untouched’ (601). In contrast, a Main area's logical block with bit code 01 (602) would be considered ‘Journaled’, meaning that modifications exist in the Journal area, but not in the Diff Updates area. A bit code of 10 may be used indicate a status of ‘Patched’ (603), meaning that some updates to the Main area's logical block exist in the Diff Update area but not in the Journal area. Finally, a bit code of 11 may be used to indicate that the logical block is ‘Updated’ (604), meaning modifications exist both in the Diff Update area and in the Journal area.

With regard to FIG. 7, an exemplary set of logs of a log-structured file system for performing an exemplary DOW method are disclosed according to embodiments of the present invention. Main area 701, Diff Updates area 702, and Journal area 703 are used to perform the exemplary Diff-On-Write approach. This approach stores read-only/unchangeable data (e.g., “cold data”) portions of a file's data in Main area 701. For example, a file's contiguous 4 KB binary stream may be classified as “cold” data. This portion of the file can be saved into one physical page of Main area 701. The read-only nature of this physical page means that all updates of this page are stored in another area (e.g., Diff Updates area 702). For example, File 704 stores “Hello” as “cold” data in Main area 701. The Journal area 703 provides shared space for gathering updates of different files. All current updates may be joined in one area comprising “hot” data. For example, when one block of Journal area 703 comprises updates for File 704 (e.g., the string “Good weather.”) and for File 2 (e.g., the string “Let's walk.”), Journal area 703 can be imagined as a mixed sequence of updates for different files. As a result, if a Journal area of one or several logs has been used to gather updates of a single file with a total accumulated size equal to the physical page size, then these updates are joined in one block of Diff Updates 702 or Main area 701, for example. The updates are stored in Diff Updates area 702 when updates from different parts of the file are present. In this example, Main area 701 may be used to store a sequence of contiguous updates for the file. Updates for file 705 and 706 are stored in the same manner, where an unchanging portion of the file is stored in Main area 701, and the remainder of the file is stored in Diff Updates area 702 or Journal Area 703.

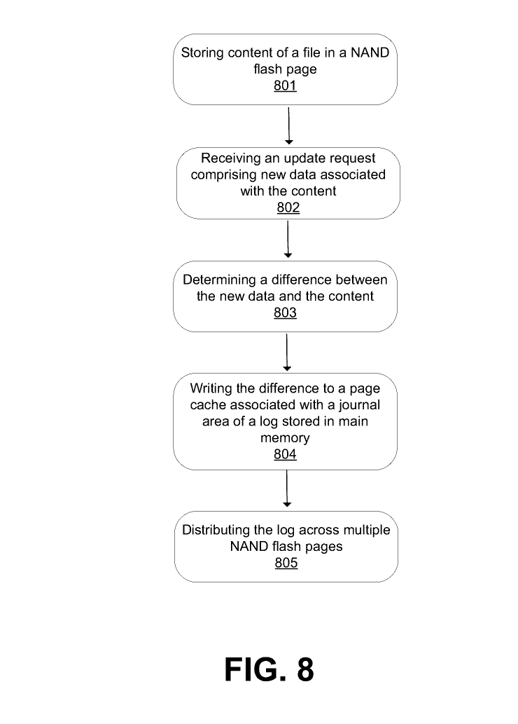

With regard to FIG. 8, an exemplary process of storing data of a file in a Main area, a Diff Updates area, and a Journal area of a log of flash-oriented file system volume is illustrated according to embodiments of the present invention. At step 801, content of a file is stored in a NAND flash page. At step 802, an update request for the file is received comprising new data associated with the content. At step 803, a difference between the new data and the content is determined. At step 804, the difference is written to a page cache associated with a journal area of a log stored in main memory. At step 805, the log is distributed across multiple NAND flash pages and the process ends.

Embodiments of the present invention are thus described. While the present invention has been described in particular embodiments, it should be appreciated that the present invention should not be construed as limited by such embodiments, but rather construed according to the following claims.

What is claimed is:

1. A method of reducing a write amplification of a flash memory device, comprising:
storing content of a file in a first NAND flash page of the flash memory device;
receiving an update request comprising new data associated with the content;
determining a difference between the new data and the content;
writing the difference to a page cache associated with a journal area of a log stored in main memory, wherein the log comprises a main area for storing an initial file state of the file and an update area for storing updates to the initial file state; and
distributing the log across multiple NAND flash pages of the flash memory device.

2. The method of claim 1, wherein a plurality of updates are joined and written to the main area before the log is written to the different NAND flash pages.

3. The method of claim 1, wherein data from the journal area associated with the file is gathered, and the gathered data is written to the main area before the log is written to the different NAND flash pages when a size of the data stored in the journal area associated with the file equals a page size of the NAND flash pages.

4. The method of claim 1, wherein the main area comprises read-only data.

5. The method of claim 1, wherein the main memory comprises DRAM.

6. The method of claim 1, further comprising pre-allocating a first logical block.

7. The method of claim 1, wherein the main, updates, and journal areas are written into a payload of the log.

8. The method of claim 1, wherein the page size is equal to 2^{x}, wherein x is a positive integer.

9. An apparatus for reducing a write amplification of a flash memory device, comprising:
a flash memory device comprising a plurality of logs, wherein each of the plurality of logs comprises a main area, a journal area, and an update area;
a main memory; and
a processor communicatively coupled to the main memory and the flash memory device that stores content of a file in a first NAND flash page of the flash memory device, receives an update request comprising new data associated with the content, determines a difference between the new data and the content, writes the difference to a page cache associated with a journal area of a log stored in the main memory, wherein the log comprises a main area for storing an initial file state of the file and an update area for storing updates to the initial file state, and distributes the log across multiple NAND flash pages of the flash memory device.

10. The apparatus of claim 9, wherein a plurality of updates are joined and written to the main area before the log is written to the different NAND flash pages.

11. The apparatus of claim 9, wherein data from the journal area associated with the file is gathered, and the gathered data is written to the main area before the log is written to the different NAND flash pages when a size of the data stored in the journal area associated with the file equals a page size of the NAND flash pages.

12. The apparatus of claim 9, wherein the main memory comprises DRAM.

13. The apparatus of claim 9, wherein the processor pre-allocates a first logical block.

14. The apparatus of claim 9, wherein the main, updates, and journal areas are gathered into a payload of the log.

15. The apparatus of claim 9, wherein the page size is equal to 2^{x}, wherein x is a positive integer.

16. A computer program product tangibly embodied in a computer-readable storage device and comprising instructions that when executed by a processor perform a method for of reducing a write amplification of a flash memory device, the method comprising:
storing content of a file in a first NAND flash page of the flash memory device;
receiving an update request comprising new data associated with the content;
determining a difference between the new data and the content;
writing the difference to a page cache associated with a journal area of a log stored in main memory, wherein the log comprises a main area for storing an initial file state of the file and an update area for storing updates to the initial file state; and
distributing the log across multiple NAND flash pages of the flash memory device.

17. The method of claim 16, wherein a plurality of updates are joined and written to the main area before the log is written to the different NAND flash pages.

18. The method of claim 16, wherein data from the journal area associated with the file is gathered, and the gathered data is written to the main area before the log is written to the different NAND flash pages when a size of the data stored in the journal area associated with the file equals a page size of the NAND flash pages.

19. The method of claim 16, further comprising pre-allocating a first logical block.

20. The method of claim 16, wherein the main memory comprises DRAM.
